(19) United States
(12) Patent Application Publication
(10) Pub. No.: US 2022/0005471 A1
(43) Pub. Date: Jan. 6, 2022

(54) OPTIMIZATION APPARATUS, OPTIMIZATION METHOD, AND PROGRAM

(71) Applicant: NIPPON TELEGRAPH AND TELEPHONE CORPORATION, Tokyo (JP)

(72) Inventors: Tomoko KAWASE, Tokyo (JP); Kazunori KOBAYASHI, Tokyo (JP)

(73) Assignee: NIPPON TELEGRAPH AND TELEPHONE CORPORATION, Tokyo (JP)

(21) Appl. No.: 17/289,703

(22) PCT Filed: Oct. 25, 2019
(86) PCT No.: PCT/JP2019/041821

§ 371 Date: Apr. 28, 2021

(30) Foreign Application Priority Data
Nov. 8, 2018 (JP) 2018-210243

(51) Int. Cl. G10L 15/22

(52) U.S. Cl. CPC G10L 15/22; G10L 2015/223

(57) ABSTRACT

To perform optimization processing of parameters with various structures without having to manually redesign processing contents of encoding and decoding. An evaluation step of obtaining an evaluated value representing an evaluation result of signal processing using a first signal processing parameter value that is a signal processing parameter; a coding step of converting, based on at least a definition file that defines an attribute of the signal processing parameter, the first signal processing parameter value into a first external parameter value that is an external parameter; a generation step of generating a second external parameter value that is the external parameter of which a value differs from the first external parameter value based on the evaluated value and the first external parameter value; and a decoding step of converting, based on the definition file, the second external parameter value into a second signal processing parameter value that is the signal processing parameter are executed.

### TECHNICAL FIELD

The present invention relates to parameter adjustment of signal processing and, particularly, to a technique to search for a value of a parameter in an automated manner.

### BACKGROUND ART

In signal processing, adjusting processing contents with an input signal may result in improving quality of an output signal. Therefore, a design is often adopted which enables parameters for adjusting processing to be set for each execution. For example, in speech enhancement software, the following parameters are set.
Noise suppression amount
Time constant used in noise estimation
Time segment when performing noise estimation at start of speech
Threshold that divides a speech segment from a non-speech segment
Output gain
Resolution of frequency analysis

It is difficult to theoretically determine a value of a parameter and, in many cases, a parameter value is empirically determined by a developer of signal processing software. For the purpose of reducing human cost for determining an appropriate parameter value, parameter adjustment can be perceived as an optimization problem and can be automated. Since an evaluated value of a parameter cannot be represented by a mathematical expression, a metaheuristic is applied as an algorithm for optimization (for example, refer to Patent Literature 1).

### PRIOR ART LITERATURE

### Patent Literature

[Patent Literature 1] Japanese Patent No. 6216809

### SUMMARY OF THE INVENTION

### Problems to be Solved by the Invention

Metaheuristically handling a parameter requires encoding for converting a parameter to be handled in signal processing into a set of values to be handled by metaheuristics and decoding for restoring values obtained by metaheuristics to a parameter to be handled in signal processing. A structure of a parameter varies depending on signal processing and, even in the same signal processing, the structure of a parameter may change if there is an update or a specification change. Therefore, there is a problem in that processing contents of encoding and decoding must be manually redesigned for every structure of a parameter that is an object.

The present invention has been made in consideration of such circumstances and an object thereof is to provide a technique that enables optimization processing of parameters with various structures to be performed without having to manually redesign processing contents of encoding and decoding.

### Means to Solve the Problems

In order to solve the problem described above, the present invention executes: an evaluation step of obtaining an evaluated value representing an evaluation result of signal processing using a first signal processing parameter value that is a signal processing parameter; a coding step of converting, based on at least a definition file that defines an attribute of the signal processing parameter, the first signal processing parameter value into a first external parameter value that is an external parameter; a generation step of generating a second external parameter value that is the external parameter of which a value differs from the first external parameter value based on the evaluated value and the first external parameter value; and a decoding step of converting, based on the definition file, the second external parameter value into a second signal processing parameter value that is the signal processing parameter.

### Effects of the Invention

In the present invention, since encoding and decoding are performed based on a definition file that defines an attribute of a signal processing parameter, optimization processing of parameters with various structures can be performed without having to manually redesign processing contents of encoding and decoding.

### BRIEF DESCRIPTION OF THE DRAWINGS

FIG. 1 is a block diagram illustrating a functional configuration of an optimization apparatus according to an embodiment.

FIG. 2 is a sequence diagram for explaining an optimization method according to the embodiment.

FIG. 3 is a flow chart for explaining the optimization method according to the embodiment.

FIG. 4 is a diagram illustrating contents of a definition file according to the embodiment.

FIG. 5 is a diagram illustrating contents of optimization progress according to the embodiment.

### DETAILED DESCRIPTION OF THE EMBODIMENTS

Hereinafter, an embodiment of the present invention will be described with reference to the drawings.

<Configuration>

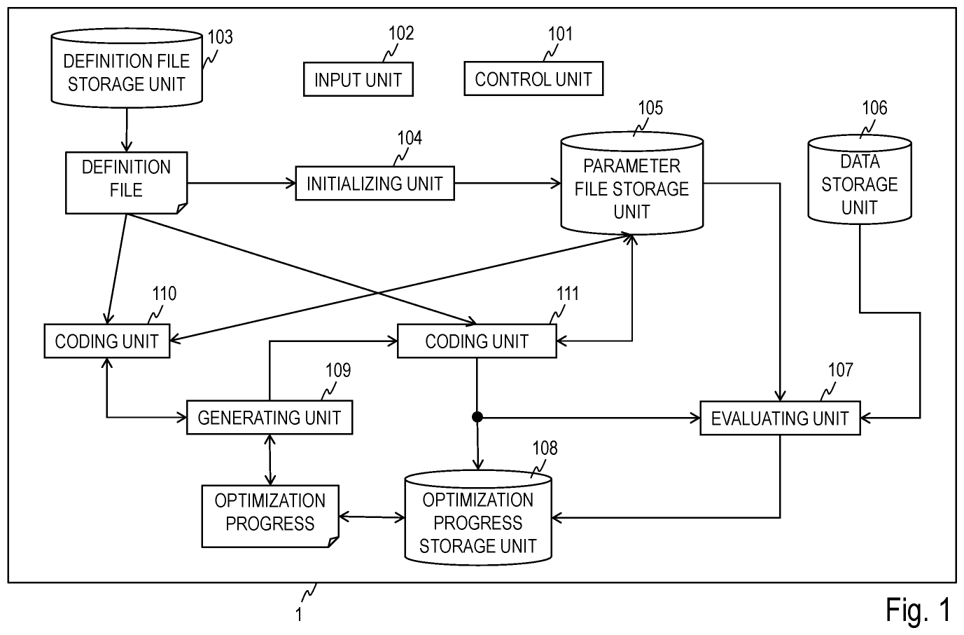

As illustrated in FIG. 1, an optimization apparatus 1 according to the present embodiment has a control unit 101, an input unit 102, a definition file storage unit 103, an initializing unit 104, a parameter file storage unit 105, a data storage unit 106, an evaluating unit 107, an optimization progress storage unit 108, a generating unit 109, a coding unit 110, and a decoding unit 111. The optimization apparatus 1 executes various steps of processing under control of the control unit 101.

<Preprocessing>

As a premise of optimization processing, the following preprocessing is executed.

Object data of signal processing to be an object of optimization processing of a parameter and a termination condition are input to the input unit 102 and stored in the data storage unit 106. There is no limit to contents of signal processing to be an object of optimization processing and any kind of signal processing may be adopted as long as processing contents are specified by a parameter. Examples of such signal processing include speech recognition processing, speech signal enhancement processing, noise cancellation processing, signal separation processing, image recognition processing, encoding processing, and machine learning processing. In a similar manner, there is no limit to the termination condition. For example, execution of the optimization processing reaching or exceeding a prescribed period of time, the number of iterations of the optimization processing reaching or exceeding a prescribed number, a change in an evaluated value of signal processing dropping to or below a prescribed value, or the like is adopted as the termination condition.

In addition, a processing function for performing signal processing to be an object of optimization processing of a parameter is set to the evaluating unit 107. For example, an algorithm for performing the signal processing is implemented in the evaluating unit 107.

Furthermore, a “definition file” that defines an attribute of a “signal processing parameter” which is a parameter specifying the signal processing is input to the input unit 102 and stored in the definition file storage unit 103. The definition file may be any kind of information as long as the information specifies a structure of the signal processing parameter. For example, the definition file includes the following pieces of information.
Names of “parameter elements” which are elements (parameters) that constitute the signal processing parameter
Variable types of the parameter elements
Among the signal processing parameter, parameter elements of which a value is changed by optimization processing and a maximum value and a maximum value of the value thereof
Among the signal processing parameter, parameter elements of which a value is fixed and the value thereof.

In addition, when the definition file corresponds to a plurality of steps of signal processing, an attribute that specifies a structure of each signal processing parameter is set to the definition file so as to enable each step of signal processing to be identified.

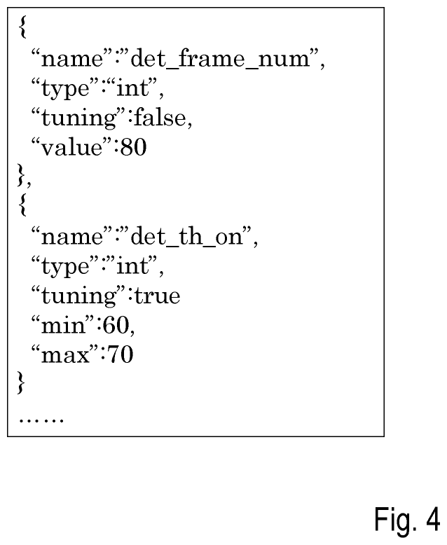

There is no limit to the data structure of the definition file. For example, the definition file includes names of parameter elements, variable types of the parameter elements, information representing whether values of the parameter elements are changeable or fixed, a maximum value and a minimum value of values of changeable parameter elements, values of fixed parameter elements, and the like which are associated for each parameter element. For example, in the case of a parameter element of which the value is changeable, the variable type of the parameter element, information indicating that the value of the parameter element is changeable, and the maximum value and the minimum value of the value of the parameter element are associated with the name of the parameter element. For example, in the case of a parameter element of which the value is fixed, the variable type of the parameter element, information indicating that the value of the parameter element is fixed, and the value of the parameter element are associated with the name of the parameter element. For example, the definition file stores a set of pairs of an item name and a value of respective pieces of information. As an example, the definition file stores a set of pairs of an item name and a value of respective pieces of information in the JSON (JavaScript (registered trademark) Object Notation) format. In the example shown in FIG. 4, a pair of “name” that is an item name and “det_frame_num” that is a name of a parameter element, a pair of “type” that is an item name and “int” that is a variable type of the parameter element, a pair of “tuning” that is an item and “false” that is information indicating that the value of the parameter element is fixed, and a pair of “value” that is an item and “80” that is a value of the parameter element are stored. Furthermore, in this example, a pair of “name” that is an item name and “det_th_on” that is a name of a parameter element, a pair of “type” that is an item name and “int” that is a variable type of the parameter element, a pair of “tuning” that is an item and “true” that is information indicating that the value of the parameter element is changeable, a pair of “min” that is an item and “60” that is the minimum value of the value of the parameter element, and a pair of “max” that is an item and “70” that is the maximum value of the value of the parameter element are stored.

<Optimization Processing>

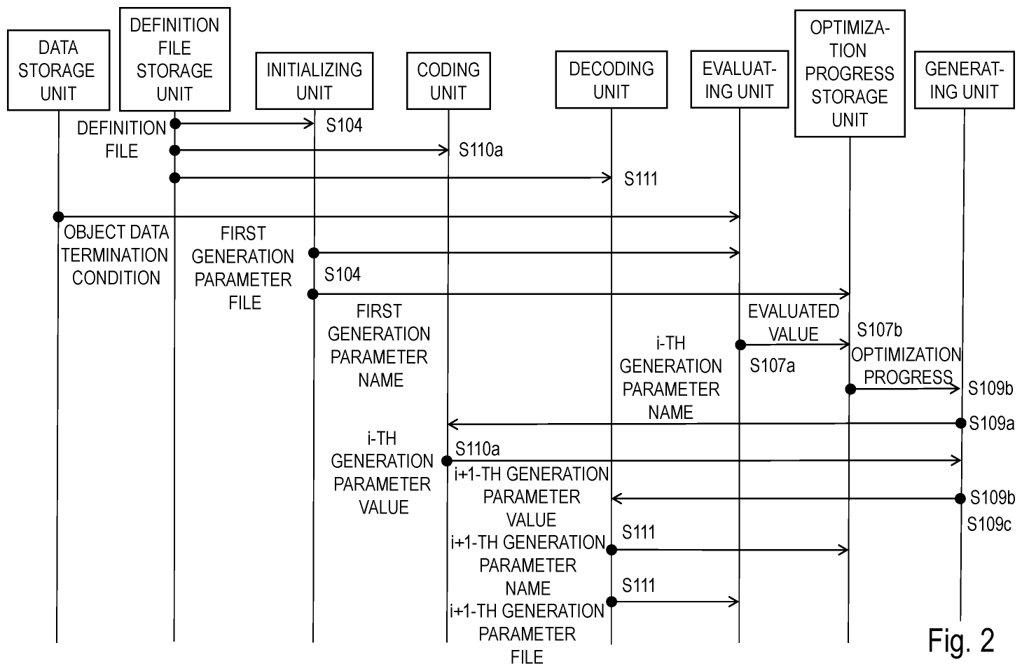

Next, optimization processing according to the present embodiment will be described with reference to FIGS. 1 to 3.

First, the control unit 101 of the optimization apparatus 1 (FIG. 1) initializes a loop counter value i that represents the number of iterations (the number of generations) of the optimization processing to 1 (step S101a).

Next, a definition file corresponding to signal processing that is an optimization object is read from the definition file storage unit 103 and sent to the initializing unit 104. The definition file defines an attribute of a signal processing parameter. Based on the sent definition file, the initializing unit 104 generates a “first generation parameter file” that represents an initial value of a signal processing parameter of the attribute defined by the definition file and outputs the “first generation parameter file”. For example, the initializing unit 104 adopts an initial value of a parameter element of which the value is fixed among the signal processing parameter as a value indicated by the definition file and randomly generates an initial value of a parameter element of which the value is changeable (in other words, the initializing unit 104 sets a generated random number as the initial value of a parameter element of which the value is changeable). It should be noted that there is no limit to the data structure of an “i-th generation parameter file”. An example of the “i-th generation parameter file” is a file that records a name of a parameter element and a value of the parameter element in a format that can be handled in signal processing that is an optimization object. In addition, the initializing unit 104 generates a “first generation parameter name” that is identification information (a name) corresponding to the generated initial value of the signal processing parameter and outputs the “first generation parameter name”. The first generation parameter file and the first generation parameter name thereof are associated with each other and stored in the parameter file storage unit 105, and the first generation parameter name is also stored in the optimization progress storage unit 108 (step S104).

An i-th generation parameter file having been read from the parameter file storage unit 105 and object data and a termination condition of the optimization processing having been read from the data storage unit 106 are input to the evaluating unit 107. The evaluating unit 107 applies signal processing using the “first signal processing parameter value” that is a signal processing parameter represented by the i-th generation parameter file to the object data, obtains an evaluated value representing an evaluation result of the signal processing, and outputs the evaluated value. The evaluated value represents, for example, performance of signal processing that is specified by the first signal processing parameter value. For example, when the signal processing is speech enhancement processing, a speech quality evaluated value, a speech recognition rate, or the like corresponds to the evaluated value. The obtained evaluated value is sent to the optimization progress storage unit 108 (step S107a).

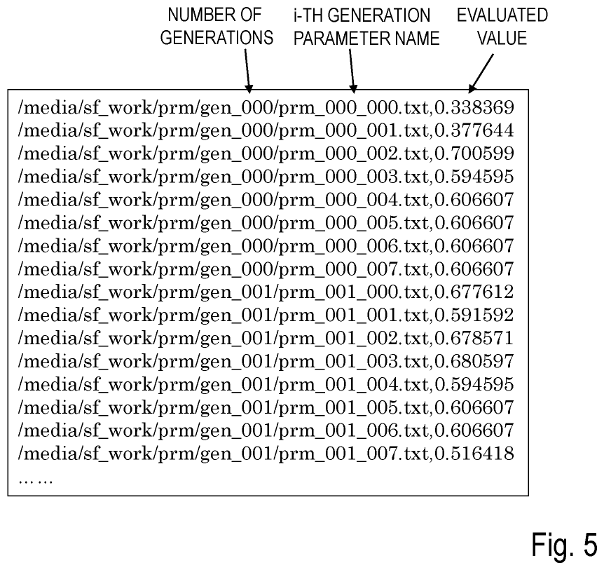

The optimization progress storage unit 108 associates an “i-th generation parameter name” corresponding to a first signal processing parameter value that is the signal processing parameter represented by the i-th generation parameter file (identification information corresponding to the first signal processing parameter value) and an evaluated value of signal processing using the first signal processing parameter value obtained in step S107a with each other and accumulates the same. Furthermore, in addition to these pieces of information, a value corresponding to the loop counter value i that represents the number of iterations (the number of generations) may also be associated and accumulated in the optimization progress storage unit 108. Alternatively, the i-th generation parameter name may include information representing the loop counter value i. In other words, the optimization progress storage unit 108 associates information corresponding to the number of iterations (the number of generations or, in other words, the loop counter value i) of processing by the evaluating unit 107, identification information (the i-th generation parameter name) corresponding to the first signal processing parameter value used in the processing by the evaluating unit 107, and an evaluated value representing an evaluation result of signal processing using the first signal processing parameter value with each other and accumulates the same. Alternatively, the optimization progress storage unit 108 may associate identification information (the i-th generation parameter name) which corresponds to the first signal processing parameter value used in the processing by the evaluating unit 107 and which includes information representing the number of iterations (the number of generations or, in other words, the loop counter value i) of processing by the evaluating unit 107 and an evaluated value representing an evaluation result of signal processing using the first signal processing parameter value with each other and accumulate the same. Accordingly, the loop counter value i can be used in optimization processing (for example, determination of a termination condition). While there is no limit to a format in which these pieces of information are to be accumulated, for example, the information can be described in the CSV format. The information to be accumulated in the optimization progress storage unit 108 will be referred to as “optimization progress”. FIG. 5 illustrates optimization progress having been accumulated in the optimization progress storage unit 108. The optimization progress illustrated in FIG. 5 represents the number of generations (the loop counter value i), an i-th generation parameter name, and an evaluated value having been associated with each other and accumulated (step S107b).

The generating unit 109 reads optimization progress from the optimization progress storage unit 108 and extracts an i-th generation parameter name from the optimization progress. The generating unit 109 sends the i-th generation parameter name to the coding unit 110 (step S109a).

The i-th generation parameter name sent from the generating unit 109 and the definition file read from the definition file storage unit 103 are input to the coding unit 110. The coding unit 110 extracts an i-th generation parameter file being associated with the input i-th generation parameter name from the parameter file storage unit 105. Next, based on the input definition file, the coding unit 110 encodes the extracted first signal processing parameter value to obtain an i-th generation parameter value (first external parameter value) that is an external parameter. In other words, the coding unit 110 identifies a structure of the first signal processing parameter value based on the definition file and, using an encoding method determined in advance, converts the first signal processing parameter value with the identified structure into an i-th generation parameter value. An external parameter is a parameter that can be optimized by a metaheuristic method determined in advance. For example, an external parameter is a parameter in a set format of a set made up of only values of parameter elements with names of the parameter element having been removed. Such an external parameter can be generated by an algorithm determined in advance as long as the structure of the first signal processing parameter value can be identified based on the definition file. There are various known techniques related to metaheuristic methods and, for example, various methods including multi-start local search, a variable neighborhood method, tabu search, and a genetic algorithm can be used. The i-th generation parameter value is sent to the generating unit 109 (step S110a).

The i-th generation parameter value sent from the coding unit 110 and the optimization progress read from the optimization progress storage unit 108 are input to the generating unit 109. Using the optimization progress (including the evaluated value described earlier) and the i-th generation parameter value (the first external parameter value), the generating unit 109 generates a new i+1-th generation parameter value (a second external parameter value that is an external parameter) by the metaheuristic method determined in advance and outputs the generated new i+1-th generation parameter value. Normally, the i+1-th generation parameter value differs from the i-th generation parameter value (the first external parameter value). The generating unit 109 generates the second external parameter value based on at least a part of the first to i-th generation parameter names (identification information) and evaluated values corresponding thereto which are accumulated in the optimization progress storage unit 108. Using at least a part of the first to i-th generation parameter names and evaluated values corresponding thereto having been obtained thus far enables the generating unit 109 to obtain an optimized i+1-th generation parameter value in an efficient manner (step S109b).

Next, in order to evaluate signal processing corresponding to the new i+1-th generation parameter value by the evaluating unit 107, the i+1-th generation parameter value is converted into an i+1-th generation parameter file that can be used in the signal processing. First, the generating unit 109 sends the i+1-th generation parameter value to the decoding unit 111. The i+1-th generation parameter value sent from the generating unit 109 and the definition file read from the definition file storage unit 103 are input to the decoding unit 111. Based on the definition file, the generating unit 109 decodes the i+1-th generation parameter value (the second external parameter value), converts the i+1-th generation parameter value into a “i+1-th generation parameter file” representing a second signal processing parameter value that is a signal processing parameter, and outputs the “i+1-th generation parameter file”. A data structure of the “i+1-th generation parameter file” is the same as the data structure of the “i-th generation parameter file” described earlier. In addition, the generating unit 109 generates an “i+1-th generation parameter name” that is identification information (a name) corresponding to the generated second signal processing parameter value and outputs the “i+1-th generation parameter name”. The i+1-th generation parameter file and the i+1-th generation parameter name thereof are associated with each other and stored in the parameter file storage unit 105, and the i+1-th generation parameter name is also stored in the optimization progress storage unit 108 (step S111).

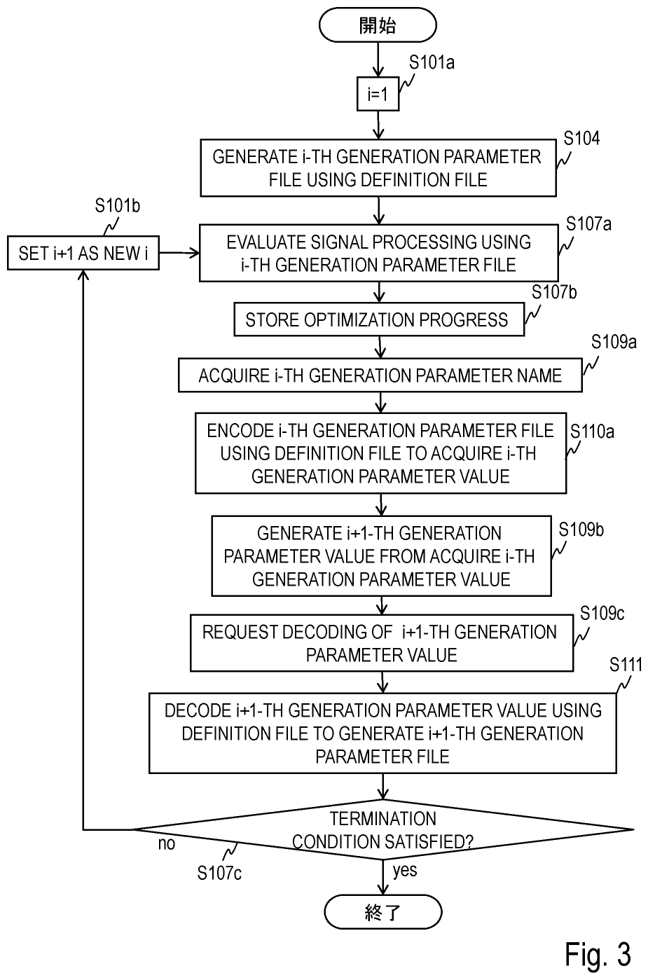

Next, the evaluating unit 107 determines whether or not the termination condition stored in the data storage unit 106 is satisfied. The termination condition is as described earlier and, for example, the evaluating unit 107 determines a termination condition such as whether or not the optimization processing (for example, the processing shown in FIG. 3) has been executed for a prescribed period of time or longer, whether or not the optimization processing has been iterated a prescribed number or times or more (for example, whether or not the loop counter value i is equal to or larger than a prescribed number), or whether or not a change in an evaluated value of signal processing has dropped to or below a prescribed value (for example, whether or not a difference between an evaluated value obtained in step S107a of a loop counter value i₁ and an evaluated value obtained in step S107a of a next loop counter value i₁+1 has dropped to or below a prescribed value) (step S107c). When the termination condition is satisfied, the optimization processing is terminated. On the other hand, when the termination condition is not satisfied, the control unit 101 sets i+1 as a new i (step S101b) and returns the processing to step S107a. Accordingly, the optimization apparatus 1 sets the second signal processing parameter value (the i+1-th generation parameter file) obtained by the decoding unit 111 as a new first signal processing parameter value (the i-th generation parameter file) and once again executes the processing of the evaluating unit 107, the processing of the coding unit 110, the processing of the generating unit 109, and the processing of the decoding unit 111 (in other words, steps S107a, S107b, 109a, S110a, S109b, S109c, S111, and S107c) (iterative processing).

When the optimization processing is temporarily suspended before the termination condition is satisfied and the optimization processing is restarted, the optimization apparatus 1 may restart the processing from any of the steps S107a, S107b, 109a, S110a, S109b, S109c, S111, and S107c. For example, when the optimization apparatus 1 restarts the optimization processing, the processing may be restarted from step S109a. In other words, using all of or a part of the evaluated values of the optimization progress accumulated in the optimization progress storage unit 108, the optimization apparatus 1 executes the processing of the evaluating unit 107, the processing of the coding unit 110, the processing of the generating unit 109, and the processing of the decoding unit 111. In the present embodiment, since optimization progress is stored in the optimization progress storage unit 108, even when the optimization processing is temporarily suspended, the optimization apparatus 1 can restart the optimization processing by using the optimization progress. In other words, the optimization apparatus 1 can restart the optimization processing using all of or a part of the evaluated values corresponding to the “first signal processing parameter value” obtained in the optimization processing prior to the suspension. Accordingly, the optimization processing can be restarted without having to use the evaluated value obtained in the optimization processing prior to the suspension and more efficiently than in a case where the processing is restarted by simply using the “first signal processing parameter value” or the “second signal processing parameter value” prior to the suspension as an initial value.

<Feature of Embodiment>

In the embodiment described above, a definition file that defines an attribute of a signal processing parameter is input to the optimization apparatus 1 and, based on the definition file, the initializing unit 104, the coding unit 110, and the decoding unit 111 set an initial value of the signal processing parameter (step S104), perform encoding from a first signal processing parameter value to a first external parameter value (step S110a), and perform decoding from a second external parameter value to a second signal processing parameter value (step S109c). Such a configuration eliminates the need to redesign the initializing unit 104, the coding unit 110, and the decoding unit 111 for every structure of the signal processing parameter. For example, even when software for performing signal processing is renewed and a parameter structure changes, there is no need to renew the algorithm that implements the initializing unit 104, the coding unit 110, and the decoding unit 111. In other words, the initializing unit 104, the coding unit 110, and the decoding unit 111 can be designed for general use so that the respective steps of processing are executed in accordance with the attribute defined in the definition file and, by simply changing the definition file, signal processing parameters of various data structures can be optimized.

In addition, in the present embodiment, since optimization progress is accumulated in the optimization progress storage unit 108, even when the optimization processing is suspended, the optimization processing after the suspension can be restarted in an efficient manner using optimization progress accumulated thus far. In other words, since every time adjustment of a parameter progresses, the optimization progress thereof is recorded, even if the optimization processing is suspended in a state where the termination condition is not satisfied, the optimization processing can be restarted without undermining efficiency. Since implementation of signal processing software and application of the signal processing software to a real environment may require intermittent adjustment of parameters, it is meaningful to be able to efficiently restart the adjustment of a parameter having been temporarily suspended. In addition, optimization progress is a piece of information with a small size such as an i-th generation parameter name (identification information) or an evaluated value which can be described by a text file and which does not compress a storage capacity of the optimization progress storage unit 108.

[Modifications]

The present invention is not limited to the embodiment described above. For example, while the initializing unit 104 sets an initial value of a signal processing parameter in the embodiment described above, the initial value of the signal processing parameter may be set manually.

In addition, in the embodiment described above, optimization progress that associates identification information (an i-th generation parameter name) corresponding to a first signal processing parameter value represented by an i-th generation parameter file and an evaluated value of signal processing using the first signal processing parameter value with each other is stored in the optimization progress storage unit 108. Furthermore, using the optimization progress and the i-th generation parameter value (the first external parameter value), the generating unit 109 generates a new i+1-th generation parameter value (a second external parameter value that is an external parameter). However, if the first signal processing parameter value that is a signal processing parameter represented by the i-th generation parameter name or the i-th generation parameter file that corresponds to the evaluated value can be identified from information such as an order of storage or a position of storage to the optimization progress or the loop counter value i stored in the optimization progress, the optimization progress need not include the i-th generation parameter name (identification information). In this case, in step S109a, instead of the generating unit 109 sending the i-th generation parameter name to the coding unit 110, the generating unit 109 sends identification information (for example, information representing an order of storage or a position of storage to the optimization progress or information representing the loop counter value i stored in the optimization progress) for identifying the first signal processing parameter value that is a signal processing parameter represented by the i-th generation parameter name or the i-th generation parameter file to the coding unit 110. In this case, in step S110a, using the identification information, the coding unit 110 may extract the i-th generation parameter file from the parameter file storage unit 105 and encode the first signal processing parameter value represented by the i-th generation parameter file to obtain an i-th generation parameter value (first external parameter value) that is an external parameter.

The various types of processing described above may not only be executed in chronological order according to the descriptions but may also be executed in parallel or on an individual basis in accordance with processing capabilities of an apparatus to be used to execute the processing or as may be necessary. For example, step S107c may be executed between step S107b and step S109a instead of after step S111, in which case the optimization processing is terminated when it is determined in step S107c that the termination condition is satisfied but the optimization processing advances to step S109a when it is determined that the termination condition is not satisfied. In this case, step S101b is to be executed after step S111. Furthermore, it is needless to say that the present invention can be appropriately modified without departing from the scope and spirit of the invention.

The apparatus described above is configured by, for example, having a general-purpose computer or a dedicated computer equipped with a processor (a hardware processor) such as a CPU (central processing unit), a memory such as a RAM (random-access memory) or a ROM (read-only memory), and the like execute a prescribed program. The computer may be equipped with a single processor and a single memory or a plurality of processors and a plurality of memories. The program may be installed on the computer or may be recorded in advance in the ROM or the like. In addition, a part of or all of the processing units may be configured using circuitry that realizes a processing function without using a program instead of circuitry such as a CPU that realizes a processing function only when a program is loaded. Circuitry constituting a single apparatus may include a plurality of CPUs.

When realizing the configurations described above with a computer, processing contents of functions which each apparatus must be equipped with are described by a program. The processing functions described above are realized on the computer by having the computer execute the program. The program describing the processing contents can be recorded in a computer-readable recording medium. An example of the computer-readable recording medium is a non-transitory recording medium. Examples of such a recording medium include a magnetic recording apparatus, an optical disk, a magneto-optical recording medium, and a semiconductor memory.

The program is distributed by, for example, selling, transferring, or lending a portable recording medium such as a DVD or a CD-ROM on which the program is recorded. Furthermore, a configuration may be adopted in which the program is stored in a storage apparatus of a server computer and the server computer transmits the program to other computers via network in order to distribute the program.

For example, a computer that executes such a program first temporarily stores the program recorded in a portable recording medium or the program transmitted from a server computer in its own storage apparatus. When executing processing, the computer reads the program stored in its own storage apparatus and executes processing in accordance with the read program. As an alternative execution mode of the program, a computer may read a program directly from a portable recording medium and execute processing in accordance with the program or, every time the program is transmitted from a server computer to the computer, the computer may sequentially execute processing in accordance with the received program. A configuration may be adopted in which a program is not transmitted to the computer from a server computer and the processing described above is executed by a so-called ASP (Application Service Provider) type service which realizes processing functions only by issuing an execution instruction and acquiring a result thereof.

Instead of executing a prescribed program on a computer to realize processing functions of the present apparatus, at least a part of the processing functions may be realized by hardware.

### DESCRIPTION OF REFERENCE NUMERALS

1 Optimization apparatus
107 Evaluating unit
109 Generating unit
110 Coding unit
111 Decoding unit
108 Optimization progress storage unit

1. An optimization apparatus, comprising processing circuitry configured to implement:
an evaluating unit which obtains an evaluated value representing an evaluation result of signal processing using a first signal processing parameter value that is a signal processing parameter;
a coding unit which converts, based on at least a definition file that defines an attribute of the signal processing parameter, the first signal processing parameter value into a first external parameter value that is an external parameter;
a generating unit which generates a second external parameter value that is the external parameter of which a value differs from the first external parameter value based on the evaluated value and the first external parameter value; and
a decoding unit which converts, based on the definition file, the second external parameter value into a second signal processing parameter value that is the signal processing parameter.

2. The optimization apparatus according to claim 1, wherein
the external parameter is a parameter that is optimizable by a metaheuristic method determined in advance.

3. The optimization apparatus according to claim 1, wherein
the optimization apparatus sets the second signal processing parameter value obtained by the decoding unit as the new first signal processing parameter value, and executes processing of the evaluating unit, processing of the coding unit, processing of the generating unit, and processing of the decoding unit once again.

4. The optimization apparatus according to claim 3, further comprising an optimization progress storage unit which accumulates the evaluated value of the signal processing using the first signal processing parameter value, wherein
the generating unit generates the second external parameter value based on the evaluated value accumulated in the optimization progress storage unit.

5. The optimization apparatus according to claim 4, wherein the optimization progress storage unit either associates information corresponding to the number of iterations of processing by the evaluating unit, identification information corresponding to the first signal processing parameter value used in the processing by the evaluating unit, and the evaluated value representing an evaluation result of the signal processing using the first signal processing parameter value with each other and accumulates the same or associates identification information which corresponds to the first signal processing parameter value used in processing by the evaluating unit and which includes information representing the number of iterations of the processing by the evaluating unit and the evaluated value representing an evaluation result of the signal processing using the first signal processing parameter value with each other and accumulates the same.

6. The optimization apparatus according to claim 4, wherein
the optimization apparatus executes processing of the evaluating unit, processing of the coding unit, processing of the generating unit, and processing of the decoding unit using the evaluated value accumulated in the optimization progress storage unit.

7. An optimization method, comprising:
an evaluation step in which an evaluating unit obtains an evaluated value representing an evaluation result of signal processing using a first signal processing parameter value that is a signal processing parameter;
a coding step in which a coding unit converts, based on at least a definition file that defines an attribute of the signal processing parameter, the first signal processing parameter value into a first external parameter value that is an external parameter;
a generation step in which a generating unit generates a second external parameter value that is the external parameter of which a value differs from the first external parameter value based on the evaluated value and the first external parameter value; and
a decoding step in which a decoding unit converts, based on the definition file, the second external parameter value into a second signal processing parameter value that is the signal processing parameter.

8. A non-transitory computer-readable recording medium storing a program for causing a computer to function as the optimization apparatus according to claim 1.
